(19) United States
(12) Patent Application Publication
(10) Pub. No.: US 2014/0072673 A1
(43) Pub. Date: Mar. 13, 2014

(54) POTATO AND OTHER INGREDIENT-BASED FOOD PRODUCTS

(71) Applicant: Ziaollah Loghmani, Indianapolis, IN (US)

(72) Inventor: Ziaollah Loghmani, Indianapolis, IN (US)

(21) Appl. No.: 13/972,716

(22) Filed: Aug. 21, 2013

Related U.S. Application Data
(60) Provisional application No. 61/691,548, filed on Aug. 21, 2012.

(51) Int. Cl. A23L 1/00

(52) U.S. Cl. CPC A23L 1/0067
USPC 426/93; 426/89

(57) ABSTRACT

Potato and other ingredient-based food products. In an exemplary embodiment of a food product of the present disclosure, the food product comprises a first layer comprising a solid food ingredient, and a second layer comprising a processed food ingredient, the second layer positioned relatively above the first layer, wherein the first layer and the second layer form a combined food product, and wherein the solid food ingredient and the processed food ingredient are selected from the group consisting of one or more of potato, rice, soybean, oat, and quinoa.

### PRIORITY

The present application is related to, and claims the priority benefit of, U.S. Provisional Patent Application Ser. No. 61/691,548, filed Aug. 21, 2012. The contents of this provisional application are hereby incorporated by reference herein.

### BACKGROUND

Typical tortilla, pancake, and pizza crust products are made from wheat or corn ingredients, whereby the wheat or corn are milled and combined with other ingredients to form the end product. A number of other potential ingredients exist in the marketplace, and it would be well received in the marketplace to utilize selected such other potential ingredients in a novel way so to produce food products made of one or more solid and processed ingredients and to offer such food products for sale and/or consumption.

### BRIEF SUMMARY

In an exemplary embodiment of a food product of the present disclosure, the food product comprises a first layer comprising a solid food ingredient, and a second layer comprising a processed food ingredient, the second layer positioned relatively above the first layer, wherein the first layer and the second layer form a combined food product, and wherein the solid food ingredient and the processed food ingredient are selected from the group consisting of one or more of potato, rice, soybean, oat, and quinoa. In another embodiment, the solid food ingredient and the processed food ingredient comprise potato. In yet another embodiment, the solid food ingredient comprises potato, and wherein the processed food ingredient comprises rice. In an additional embodiment, the solid food ingredient and the processed food ingredient comprise potato and rice

In an exemplary embodiment of a food product of the present disclosure, the processed food ingredient is combined with a binder. In an additional embodiment, the binder is selected from the group consisting of whole egg and egg white. In yet an additional embodiment, the binder comprises a starch. In another embodiment, the processed food ingredient is combined with a liquid and a binder selected from the group consisting of whole egg, egg white, and starch.

In an exemplary embodiment of a food product of the present disclosure, when the processed food ingredient is positioned relatively above the first layer, a first portion of the processed food ingredient remains positioned above the first layer, and a second portion of the processed food ingredient is positioned within the first layer. In another embodiment, the solid food ingredient comprises one or more potato slices. In yet another embodiment, the one or more potato slices are raw, and in another embodiment, the one or more potato slices are cooked. In an additional embodiment, the one or more potato slices have at least one of a length and/or a width dimension that is relatively larger than a thickness dimension. In yet an additional embodiment, the one or more potato slices comprises a plurality of potato slices positioned adjacent to one another, and wherein one or more gaps are defined in between the plurality of potato slices.

In an exemplary embodiment of a food product of the present disclosure, solid food ingredient comprises rice selected from the group consisting of uncooked rice and cooked rice, and wherein one or more gaps are formed within the first layer of the rice. In an additional embodiment, solid food ingredient comprises soybeans selected from the group consisting of uncooked soybeans and cooked soybeans, and wherein one or more gaps are formed within the first layer of the soybeans. In yet an additional embodiment, the solid food ingredient comprises oats selected from the group consisting of raw oats, milled oats, and cooked oats, and wherein one or more gaps are formed within the first layer of the oats. In another embodiment, the solid food ingredient comprises quinoa selected from the group consisting of raw quinoa and cooked quinoa, and wherein one or more gaps are formed within the first layer of the quinoa.

In an exemplary embodiment of a food product of the present disclosure, the solid food ingredient comprises two or more of potato, rice, soybean, oat, and quinoa, and wherein when the solid food ingredient is placed as the first layer, one or more gaps are defined within the first layer of the solid food ingredient. In another embodiment, the processed food ingredient comprises potato. In yet another embodiment, the processed food ingredient comprises rice. In an additional embodiment, the processed food ingredient further comprises rice. In yet an additional embodiment, the processed food ingredient comprises two or more of potato, rice, soybean, oat, and/or quinoa.

In an exemplary embodiment of a food product of the present disclosure, the processed food ingredient is combined with a binder selected from the group consisting of whole egg, egg white, and starch. In an additional embodiment, the processed food ingredient is combined with a liquid. In yet an additional embodiment, the processed food ingredient is cooked.

In an exemplary embodiment of a food product of the present disclosure, when the processed food ingredient is positioned relatively above the first layer, a first portion of the processed food ingredient remains positioned above the first layer of the plurality of potato slices, and a second portion of the processed food ingredient is positioned within the one or more gaps defined within the first layer. In another embodiment, the combined food product is selected from the group consisting of a tortilla, a food wrap, a pancake, and a crust. In yet another embodiment, the processed food ingredient is further combined with salt. In an additional embodiment, the processed food ingredient is further combined with an oil. In yet an additional embodiment, the processed food ingredient is further combined with one or more spices.

In an exemplary embodiment of a food product of the present disclosure, the processed food ingredient is mechanically processed using a mechanical process selected from the group consisting of mixing, mashing, grinding, kneading, and pressing. In an additional embodiment, the combined food product is treated so that it becomes relatively crisp. In yet an additional embodiment, the combined food product is treated using a baking process so that the first layer becomes relatively crisp.

In an exemplary embodiment of a food product of the present disclosure, the combined food product is treated by placing the first layer on a heated substrate. In another embodiment, the heated substrate has a quantity of an oil positioned thereon, and wherein the first layer is positioned on the quantity of the oil on the heated substrate. In yet another embodiment, the combined food product is treated by placing the first layer in a quantity of heated oil. In an additional embodiment, the combined food product is further treated using a treatment selected from the group consisting of one or more of refrigerated, frozen, heat-sealed, baked, fried, and/or microwaved.

In an exemplary embodiment of a food product of the present disclosure, the food product further comprises a quantity of a sauce positioned above the second layer, the sauce comprising a tomato ingredient. In an additional embodiment, the food product further comprises a quantity of cheese positioned above the second layer. In yet an additional embodiment, the food product further comprises at least one additional pizza topping positioned above the second layer, the at least one additional pizza topping selected from the group consisting of the tomato ingredient, a second tomato ingredient, a second cheese ingredient, a meat ingredient, a vegetable ingredient, a spice ingredient, an herb ingredient, a seafood ingredient, and a nut ingredient.

In an exemplary embodiment of a food product of the present disclosure, the food product further comprises a quantity of a sugary ingredient positioned above the second layer, the sugary ingredient comprising a quantity of a sugar. In another embodiment, the food product further comprises at least one additional pizza topping positioned above the second layer, the at least one additional pizza topping selected from the group consisting of cinnamon, chocolate, candy, marshmallow, nutmeg, and nut. In yet another embodiment, the combined product is baked, fried, and/or microwaved.

In an exemplary embodiment of a food product of the present disclosure, the food product comprises a total of no more than three individual ingredients. In an additional embodiment, the food product comprises a total of no more than four individual ingredients. In yet additional embodiment, the food product comprises a total of five or more individual ingredients. In another embodiment, the food product is gluten-free.

In an exemplary embodiment of a food product of the present disclosure, the food product, comprises a first layer comprising a solid food ingredient, and a second layer comprising a processed food ingredient, the second layer positioned relatively above the first layer, wherein the first layer and the second layer form a combined food product, and wherein the solid food ingredient and the processed food ingredient are selected from the group consisting of one or more of potato, rice, soybean, oat, and quinoa, wherein when the processed food ingredient is positioned relatively above the first layer, a first portion of the processed food ingredient remains positioned above the first layer, and a second portion of the processed food ingredient is positioned within the first layer. In another embodiment, the processed food ingredient is further combined with at least two additional ingredients selected from the group consisting of a liquid, a binder, a salt, an oil, and a spice.

In an exemplary embodiment of a food product of the present disclosure, the food product, comprises a first layer comprising a solid food ingredient and defining one or more gaps therein, and a second layer comprising a processed food ingredient, the second layer positioned relatively above the first layer, wherein the first layer and the second layer form a combined food product, wherein the solid food ingredient and the processed food ingredient are selected from the group consisting of one or more of potato, rice, soybean, oat, and quinoa, wherein when the processed food ingredient is positioned relatively above the first layer, a first portion of the processed food ingredient remains positioned above the first layer, and a second portion of the processed food ingredient is positioned within the first layer within at least one of the one or more gaps, and wherein the combined food product is treated by placing the first layer on a heated substrate having a quantity of an oil positioned thereon so that the first layer becomes relatively crisp.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1A shows a side view of a food product, according to an exemplary embodiment of the present disclosure;

FIG. 1B shows a block diagram of selected ingredients of a food product according to an exemplary embodiment of the present disclosure; and

FIG. 2 shows a top view of a food product, according to an exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Various food products of the present disclosure are prepared using potato and/or rice ingredients. Certain embodiments of food products of the present disclosure are prepared using soybean, oat, and/or quinoa ingredients, either with or without the potato and/or rice ingredients.

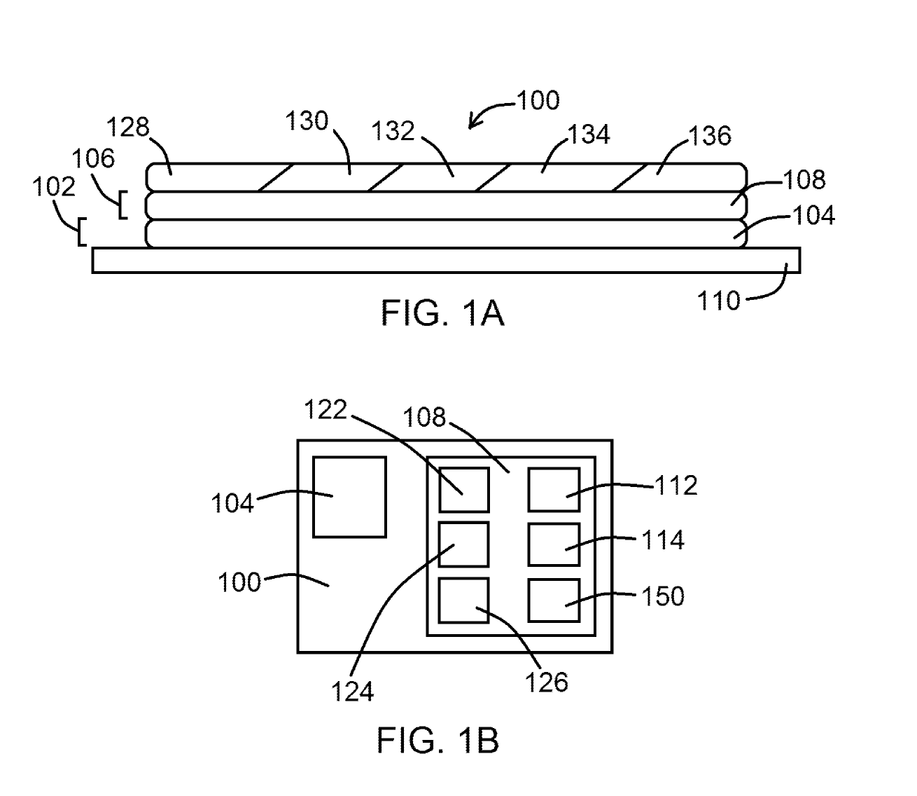

At least one exemplary food product 100 of the present disclosure includes the following ingredients and is prepared as follows. In at least one food product 100 embodiment of the present disclosure, and as shown in FIG. 1A, food product 100 comprises a first layer 102 comprising a solid food ingredient 104, and a second layer 106 comprising a processed food ingredient 108, wherein the second layer 106 is positioned relatively above the first layer 102, and wherein the first layer 102 and the second layer 106 form a combined food product 100. As referenced above, and in various food product 100 embodiments of the present disclosure, the solid food ingredient 104 and the processed food ingredient 108 are selected from the group consisting of one or more of potato, rice, soybean, oat, and quinoa. Said ingredients may be prepared upon a substrate 110, as shown in FIG. 1A, such as a countertop, a baking sheet, a pizza sheet, a cutting board, a plate, an oven rack, a wire rack, a frying pan, a griddle, and/or other substrates 110 known or developed in the art.

In various embodiments of food products 100 of the present disclosure, solid food ingredient 104 and processed food ingredient 108 each comprise potato. In at least one embodiment, solid food ingredient 104 comprises potato and processed food ingredient 108 comprises rice. In various embodiments, solid food ingredient 104 and processed food ingredient 108 each comprise potato and rice.

In various food product 100 embodiments of the present disclosure, and as depicted in the block diagram shown in FIG. 1B, processed food ingredient 108 is combined with a binder 112. In various embodiments, the binder 112 is selected from the group consisting of whole egg (meaning the egg white and the egg yolk, minus the egg shell) and egg white (meaning the absence of the egg yolk). In at least one embodiment, binder 112 comprises a starch. In various food product 100 embodiments, processed food ingredient 108 is combined with a liquid 114 (such as water or broth, for example), as shown in the block diagram of FIG. 1B, and a binder 112 selected from the group consisting of whole egg, egg white, and starch.

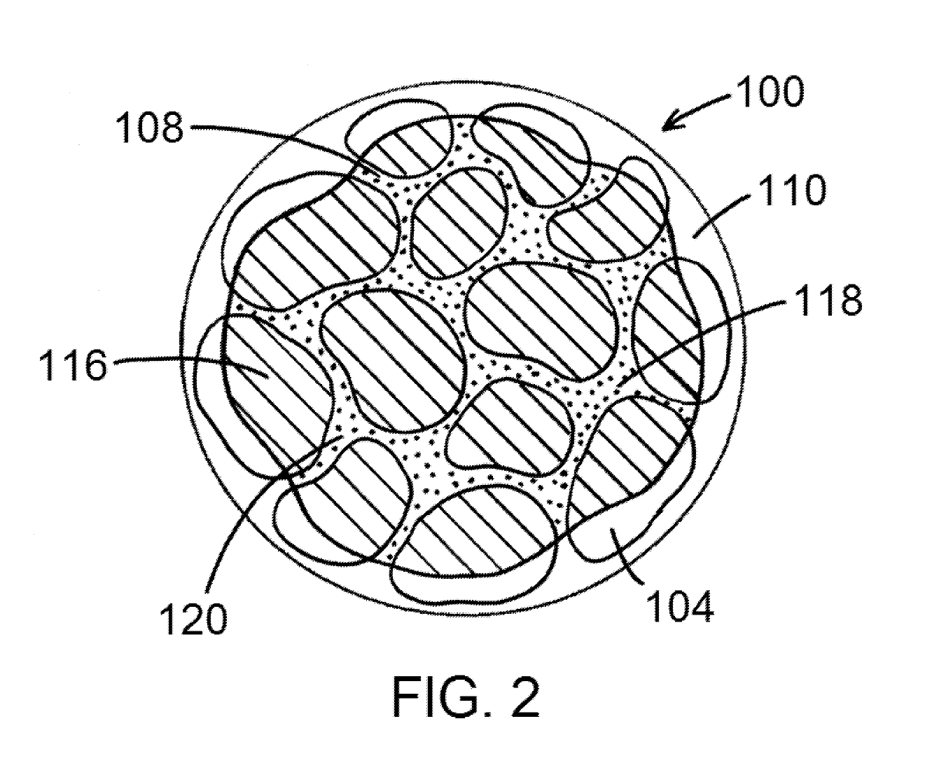

In various food product 100 embodiments of the present disclosure, when processed food ingredient 108 is positioned relatively above first layer 102, a first portion 116 of processed food ingredient 108 remains positioned above first layer 102, and a second portion 118 of processed food ingredient 108 is positioned within first layer 102. FIG. 2 shows a top view of an exemplary food product 100 of the present disclosure positioned upon a substrate 110, whereby first portion 116 of processed food ingredient 108 (shown by way of an irregular round shape having a relatively thick border) is depicted as diagonal lines upon solid food ingredient 104, and whereby second portion 118 of processed food ingredient 108 is depicted as dotted lines in between portions of solid food ingredient 104. Said portions may be referred to herein as gap(s) 120, as shown in FIG. 2 and referenced further herein.

In various food product 100 embodiments of the present disclosure, solid food ingredient 104 comprises one or more potato slices, and in at least a few embodiments, the potato slices are raw. In at least one embodiment, the potato slices have at least one of a length and/or a width dimension that is relatively larger than a thickness dimension, such as an uncooked potato chip that has a relatively large surface area as compared to its thickness. In various food products 100 of the present disclosure, a plurality of potato slices are positioned adjacent to one another, such as the solid food ingredient 104 shown in FIG. 2, wherein one or more gaps 120 are defined in between the plurality of potato slices.

Additional solid food ingredients 104 other than potato may be used to prepare food products 100 of the present disclosure. For example, and in several embodiments, solid food ingredient 104 comprises rice selected from the group consisting of uncooked rice and cooked rice. In other food product 100 embodiments, solid food ingredient 104 comprises soybeans selected from the group consisting of uncooked soybeans and cooked soybeans. In various other embodiments, solid food ingredient 104 comprises oats selected from the group consisting of raw oats, milled oats, and cooked oats. In additional embodiments, solid food ingredient 104 comprises quinoa selected from the group consisting of raw quinoa and cooked quinoa. In any number of embodiments, one or more gaps 120 may be formed within first layer 102 of solid food ingredient 104.

In various embodiments of food products 100 of the present disclosure, solid food ingredient 104 comprises two or more of potato, rice, soybean, oat, and/or quinoa, and when solid food ingredient 104 is placed as first layer 102, one or more gaps 120 are defined within first layer 102 of solid food ingredient 104.

In any number of food products 100 of the present disclosure, processed food ingredient 108 comprises potato and/or rice, and may comprise two or more of potato, rice, soybean, oat, and/or quinoa. In various such embodiments, processed food ingredients 108 are combined with a binder 112 selected from the group consisting of whole egg, egg white, and starch, and may be further combined with a liquid 114. In various embodiments, processed food ingredients 108 are cooked (such as boiled, baked, microwaved, sautéed, broiled, and/or fried).

In food product 100 embodiments whereby solid food ingredient 104 comprises a plurality of potato slices, when processed food ingredient 108 is positioned relatively above first layer 102, a first portion 116 of processed food ingredient 108 remains positioned above first layer 102 of the plurality of potato slices, and a second portion 118 of the processed food ingredient 108 is positioned within the one or more gaps 120 defined within the first layer 102.

Food products 100 can comprise a number of different food products 100, such as tortillas, food wraps, pancakes, and crusts. In various embodiments of food products 100 of the present disclosure, and as shown in FIG. 1B, processed food ingredient 108 may be further combined with one or more salts 122, oils 124, and/or spices 126.

In various food product 100 embodiments of the present disclosure, processed food ingredient 108 is mechanically processed using a mechanical process such as mixing, mashing, grinding, kneading, and pressing.

In a number of embodiments of food products 100 of the present disclosure, food product(s) 100 is/are treated so that it/they become relatively crisp, which may be by baking or frying food product(s) 100. In at least one embodiment, food product 100 is treated by placing the first layer 102 on a heated substrate 110, such as a frying pan, baking sheet, or wire rack. In various embodiments, heated substrate 110 has a quantity of an oil 124 positioned thereon, and first layer 102 of food product 100 is positioned on quantity of oil 124 on heated substrate 110. In at least some embodiments, food product 100 is treated by placing first layer 102 of solid food ingredient 104 in a quantity of heated oil 124, such as by way of a metal rack/mesh conveyor belt system so that first layer 102 and optionally second layer 106 contact said heated oil 124. In various food product embodiments, food product 100 is further treated using a treatment selected from the group consisting of one or more of refrigeration, freezing, heat-sealing, baking, frying, or microwaving.

In at least some food product 100 embodiments of the present disclosure, food product 100 further comprises a quantity of a sauce 128 positioned above second layer 106, wherein sauce 128 may comprises a tomato ingredient 130 such as pizza sauce, tomato paste, diced tomatoes, and/or pasta sauce. In several embodiments, food products 100 further comprise a quantity of cheese 132 positioned above second layer 106. Cheeses 132, in various embodiments, can include any number of cheeses such as mozzarella, feta, goat, cheddar, colby, monterrey jack, etc., to form a cheesy flatbread, a pizza, and/or another product with cheese and/or sauce therein. In various additional embodiments, food products 100 comprise at least one additional pizza topping 134 positioned above second layer 106, whereby the pizza topping(s) 134 is/are selected from the group consisting of tomato ingredient 130, a second tomato ingredient, a second cheese ingredient, a meat ingredient, a vegetable ingredient, a spice ingredient, an herb ingredient, a seafood ingredient, and a nut ingredient.

Regarding embodiments of food products 100 of the present disclosure that are relatively sweet (such as a dessert pizza, for example), such food products 100 may comprise a quantity of a sugary ingredient 136 positioned above second layer 106, sugary ingredient 136 comprising a quantity of a sugar. In various additional embodiments, food products 100 further comprise at least one additional pizza topping 134 positioned above second layer 106, additional pizza topping 134 selected from the group consisting of cinnamon, chocolate, candy, marshmallow, nutmeg, and nut.

As referenced above, sauce 128, tomato ingredient 130, cheese 132, additional pizza topping 134, and sugary ingredient 136 are shown in FIG. 1A as being above second layer 106 but separated by diagonal lines. The diagonal lines are not intended to identify any particular location above second layer 106 to place said items, and instead are intended so that each separate item can be properly reflected in the figures.

In various embodiments of food products 100 of the present disclosure, including those having one or more of sauce 128, tomato ingredient 130, cheese 132, additional pizza topping 134, and/or sugary ingredient 136 positioned therein, food product 100 may be baked, fried, and/or microwaved. In at least several food product 100 embodiments of the present disclosure, said embodiments may comprise a total of no more than three individual ingredients, a total of no more than four individual ingredients, or a total of five or more individual ingredients. “Ingredients”, in the context of the number of individual ingredients, may refer to solid food ingredient 104, processed food ingredient 108, and/or ingredient types, such as one or more potato-based ingredients, for example. In various embodiments of food products 100 of the present disclosure, said food products are gluten-free.

The various placement, positioning, processing, and or treatment steps referenced herein may be used in one or more exemplary methods of the present disclosure to produce various food products 100 as referenced herein.

### Exemplary Recipes

The following are various exemplary recipes and/or processing steps to prepare various food products 100 of the present disclosure. The following recipes and/or processing steps are exemplary and do not comprise a cumulative list of all possible recipes and/or processing steps, as others are also contemplated herein.

Exemplary recipes to produce exemplary products 100 of the present disclosure include at least one solid food ingredient 104, such as potato, in one or more formats, such as sliced potato, shredded potato, diced potato, strips of potato, french fry cut potato, basket weave cut potato, crinkle cut potato, and/or hash brown potato, for example, which is used to prepare a first layer 102. Such a first layer 102 may have a consistent thickness or a somewhat varied thickness. In various embodiments, first layer 102 is at or about ⅛″ thick to at or about ½″ thick, or even thicker than ½″.

Such an exemplary recipe to produce food product 100 further comprises at least one processed food ingredient 108, such as potato in a general slurry and/or mashed format/consistency. Such a processed food ingredient 108 may be combined with one or more liquids 114 (such as a quantity of water), a binder 112, a salt 122 (such as table salt or sea salt), and/or one or more spices 126, to prepare a final version of processed food ingredient 108. In addition, one or more colors 150 (such as a natural or artificial color) may be used to prepare processed food ingredient 108, noting that one or more colors 150 may actually be the same as one or more spices 126, as various spices 126 also provide various colors to processed food ingredient. Upon combination and processing, processed food ingredient 108 may form a syrupy or honey-like consistency, such as a paste, for example.

Processed food ingredient 108, as mentioned above and as generally referenced herein, can be combined with a first layer 102 of solid food ingredient 104 to form a version of a product 100 of the present disclosure. In various embodiments, processed food ingredient 108 can be added to first layer 102 of solid food ingredient, so that when processed food ingredient 108 is positioned relatively above first layer 102, a first portion 116 of processed food ingredient 108 remains positioned above first layer 102, and a second portion 118 of processed food ingredient 108 is positioned within first layer 102, such as shown in FIG. 2 and referenced generally herein. In various embodiments, second portion 118 of processed food ingredient forms a layer at or about 1/16″ thick to at or about ⅛″ thick, or perhaps thicker than ⅛″. After combination of solid food ingredient 104 and processed food ingredient 108, that combination can be processed as generally referenced herein.

Additional exemplary recipes to produce food products 100 of the present disclosure include at least one solid food ingredient 104, such as rice, soybean, oat, and/or quinoa, in one or more cooked formats, which is used to prepare a first layer 102. Such a first layer 102 may have a consistent thickness or a somewhat varied thickness. In various embodiments, first layer 102 is at or about ⅛″ thick to at or about ½″ thick, or even thicker.

Such an exemplary recipe further comprises at least one processed food ingredient 108, such as rice, soybean, oat, and/or quinoa in a general slurry and/or mashed format/consistency, which can comprise a mixture of cooked rice, soybean, oat, and/or quinoa with ground rice, soybean, oat, and/or quinoa, or a quantity of ground rice, soybean, oat, and/or quinoa that is not mixed with the cooked ingredient(s). Such a processed food ingredient 108 may be combined with one or more liquids 114 (such as a quantity of water), a binder 112, a salt 122 (such as table salt or sea salt), and/or one or more spices 126 (such as pepper, for example), to prepare a final version of processed food ingredient 108. In addition, one or more colors 150 (such as a natural or artificial color) may be used to prepare processed food ingredient 108, noting that one or more colors 150 may actually be the same as one or more spices 126, as various spices 126 also provide various colors to processed food ingredient. Upon combination and processing, processed food ingredient 108 may form a syrupy or honey-like consistency, such as a paste, for example.

Processed food ingredient 108, as mentioned above and as generally referenced herein, can be combined with first layer 102 of solid food ingredient 104 to form a version of a product 100 of the present disclosure. In various embodiments, processed food ingredient 108 can be added to first layer 102 of solid food ingredient, so that when processed food ingredient 108 is positioned relatively above first layer 102, a first portion 116 of processed food ingredient 108 remains positioned above first layer 102, and a second portion 118 of processed food ingredient 108 is positioned within first layer 102, such as shown in FIG. 2 and referenced generally herein. In various embodiments, second portion 118 of processed food ingredient forms a layer at or about 1/16″ thick to at or about ⅛″ thick, or perhaps thicker than ⅛″. After combination of solid food ingredient 104 and processed food ingredient 108, that combination can be processed as generally referenced herein.

While various embodiments of potato and other ingredient-based food products and methods of making the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A food product, comprising:
a first layer comprising a solid food ingredient; and
a second layer comprising a processed food ingredient, the second layer positioned relatively above the first layer, wherein the first layer and the second layer form a combined food product, and wherein the solid food ingredient and the processed food ingredient are selected from the group consisting of one or more of potato, rice, soybean, oat, and quinoa.

2. The food product of claim 1, wherein the processed food ingredient is combined with a liquid and a binder selected from the group consisting of whole egg, egg white, and starch.

3. The food product of claim 1, wherein when the processed food ingredient is positioned relatively above the first layer, a first portion of the processed food ingredient remains positioned above the first layer, and a second portion of the processed food ingredient is positioned within the first layer.

4. The food product of claim 1, wherein the solid food ingredient comprises a plurality of potato slices positioned adjacent to one another, and wherein one or more gaps are defined in between the plurality of potato slices.

5. The food product of claim 1, wherein solid food ingredient comprises rice selected from the group consisting of uncooked rice and cooked rice, and wherein one or more gaps are formed within the first layer of the rice.

6. The food product of claim 1, wherein the solid food ingredient comprises soybeans selected from the group consisting of uncooked soybeans and cooked soybeans, and wherein one or more gaps are formed within the first layer of the soybeans.

7. The food product of claim 1, wherein the solid food ingredient comprises oats selected from the group consisting of raw oats, milled oats, and cooked oats, and wherein one or more gaps are formed within the first layer of the oats.

8. The food product of claim 1, wherein the solid food ingredient comprises quinoa selected from the group consisting of raw quinoa and cooked quinoa, and wherein one or more gaps are formed within the first layer of the quinoa.

9. The food product of claim 1, wherein the solid food ingredient comprises two or more of potato, rice, soybean, oat, and/or quinoa, and wherein when the solid food ingredient is placed as the first layer, one or more gaps are defined within the first layer of the solid food ingredient.

10. The food product of claim 1, wherein the processed food ingredient comprises two or more of potato, rice, soybean, oat, and/or quinoa.

11. The food product of claim 9, wherein the processed food ingredient comprises two or more of potato, rice, soybean, oat, and/or quinoa.

12. The food product of claim 1, wherein the combined food product is selected from the group consisting of a tortilla, a food wrap, a pancake, and a crust.

13. The food product of claim 1, wherein the processed food ingredient is further combined with at least one additional ingredient selected from the group consisting of a salt, an oil, and a spice.

14. The food product of claim 1, wherein the processed food ingredient is mechanically processed using a mechanical process selected from the group consisting of mixing, mashing, grinding, kneading, and pressing.

15. The food product of claim 1, wherein the combined food product is treated by placing the first layer on a heated substrate having a quantity of an oil positioned thereon so that the first layer becomes relatively crisp.

16. The food product of claim 1, further comprising:
a quantity of a sauce positioned above the second layer, the sauce comprising a tomato ingredient; and
a quantity of cheese positioned above the second layer.

17. The food product of claim 1, further comprising:
a quantity of a sugary ingredient positioned above the second layer, the sugary ingredient comprising a quantity of a sugar; and
at least one additional topping positioned above the second layer, the at least one additional topping selected from the group consisting of cinnamon, chocolate, candy, marshmallow, nutmeg, and nut.

18. A food product, comprising:
a first layer comprising a solid food ingredient; and
a second layer comprising a processed food ingredient, the second layer positioned relatively above the first layer, wherein the first layer and the second layer form a combined food product, and wherein the solid food ingredient and the processed food ingredient are selected from the group consisting of one or more of potato, rice, soybean, oat, and quinoa;
wherein when the processed food ingredient is positioned relatively above the first layer, a first portion of the processed food ingredient remains positioned above the first layer, and a second portion of the processed food ingredient is positioned within the first layer.

19. The food product of claim 18, wherein the processed food ingredient is further combined with at least two additional ingredients selected from the group consisting of a liquid, a binder, a salt, an oil, and a spice.

20. A food product, comprising:
a first layer comprising a solid food ingredient and defining one or more gaps therein; and
a second layer comprising a processed food ingredient, the second layer positioned relatively above the first layer, wherein the first layer and the second layer form a combined food product;
wherein the solid food ingredient and the processed food ingredient are selected from the group consisting of one or more of potato, rice, soybean, oat, and quinoa;
wherein when the processed food ingredient is positioned relatively above the first layer, a first portion of the processed food ingredient remains positioned above the first layer, and a second portion of the processed food ingredient is positioned within the first layer within at least one of the one or more gaps; and
wherein the combined food product is treated by placing the first layer on a heated substrate having a quantity of an oil positioned thereon so that the first layer becomes relatively crisp.
